(19) United States
(12) Patent Application Publication
(10) Pub. No.: US 2026/0080511 A1
(43) Pub. Date: Mar. 19, 2026

(54) DENOISING DIGITAL IMAGES WITH NATURAL NOISE UTILIZING A DOMAIN GAP GENERATIVE ADVERSARIAL NEURAL NETWORK

(71) Applicant: Adobe Inc., San Jose, CA (US)

(72) Inventors: Bo Sun, San Jose, CA (US); Michael Gharbi, San Francisco, CA (US)

(21) Appl. No.: 18/887,787

(22) Filed: Sep. 17, 2024

(51) Int. Cl. G06T 5/60

(52) U.S. Cl. CPC G06T 5/60; G06T 2207/20081; G06T 2207/20084

(57) ABSTRACT

The present disclosure relates to systems, non-transitory computer-readable media, and methods for training and utilizing a domain gap generative adversarial network. More specifically, in one or more embodiments, the disclosed systems train a domain gap generative adversarial network by generating predicted denoised images from the digital images with synthetic noise and predicted denoised images from the digital images with natural noise. The disclosed systems also utilize a discriminator to generate a first discrimination between the ground-truth digital images for the digital images with synthetic noise and the predicted denoised images for the digital images with synthetic noise, and a second discrimination between the predicted denoised images for the digital images with natural noise and the predicted denoised images for the digital images with synthetic noise. The disclosed system further modify parameters of the domain gap generative adversarial network based on the first discrimination and the second discrimination.

### BACKGROUND

Recent years have seen significant improvements in digital image editing. For example, conventional systems can denoise digital images to enhance them visually and reconstruct fine details. To illustrate, conventional systems utilize deep neural networks to denoise digital images, including generative adversarial networks. However, many conventional image editing systems train denoising neural networks using synthetic noise.

Although conventional systems denoise digital images, such systems have a number of problems in relation to accuracy and efficiency. For instance, conventional systems inaccurately denoise images because they utilize neural networks trained using synthetic noise. Because synthetic noise uniformly places noise on a digital image, synthetic noise inaccurately portrays the noise distribution of the natural noise of digital images. Because of this disparity, or domain gap, between natural noise and synthetic noise, conventional image editing systems generate inaccurate results because their models cannot accurately address natural noise in digital images.

Further, conventional systems can further cause inaccuracy by utilizing neural networks trained using individually-generated digital image pairs with natural noise. To illustrate, such image pairs simulate a noisy and clean version of the same image by capturing two separate images of the same environment. Conventional systems require generation of these image pairs in strictly controlled environments with precise and computationally expensive post-processing. Accordingly, even small, difficult to detect variations or errors in generation of these individually-generated digital image pairs causes significant inaccuracies if used to train a denoising neural network.

Additionally, many conventional systems lack efficiency. To illustrate, the structure of generative adversarial networks in most image editing systems utilizes input/output pairs for ground-truth data. As just mentioned, to generate natural noise for these input/output pairs, conventional systems require strictly controlled photography and post-processing that utilizes excess time and computing resources. Further, any small misalignments for these input/output pairs will further waste computing time and resources by yielding excessively long training times or failing to result in sufficient loss minimization during training.

These along with additional problems and issues exist with regard to conventional image editing systems.

### BRIEF SUMMARY

Embodiments of the present disclosure provide benefits and/or solve one or more of the foregoing or other problems in the art with systems, non-transitory computer-readable media, and methods for training and utilizing a domain gap generative adversarial network to bridge the gap between real data and synthetic data. More specifically, in one or more embodiments, the domain gap generative adversarial system generates one training dataset of digital images with synthetic noise and corresponding ground-truth digital images and a second training dataset of digital images with natural noise. Further, in one or more embodiments, the domain gap generative adversarial system utilizes the two training datasets to train a domain gap generative adversarial network. More specifically, in one or more embodiments, the domain gap generative adversarial system iteratively trains the domain gap adversarial network by utilizing both training datasets as input for training. Furthermore, in one or more embodiments, the domain gap generative adversarial system applies a discriminator between the ground-truth digital images for the digital images with synthetic noise, the predicted denoised images for the digital images with synthetic noise, and the predicted denoised images for the digital images with natural noise. Specifically, the discriminator is used to discriminate the ground truth data not only from the synthetic data but also from the real data.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a domain gap generative adversarial system can operate in accordance with one or more embodiments.

FIG. 2 illustrates a process for applying a domain gap generative adversarial network in accordance with one or more embodiments.

FIG. 3 illustrates a process for training a domain gap generative adversarial network in accordance with one or more embodiments.

FIG. 4 illustrates a process for training a domain gap generative adversarial network with two discriminators in accordance with one or more embodiments.

FIG. 5 illustrates qualitative denoising results for a variety of generative adversarial network types in accordance with one or more embodiments.

FIG. 6 illustrates a schematic diagram of a domain gap generative adversarial system in accordance with one or more embodiments.

FIG. 7 illustrates a flowchart of a series of acts for training a domain gap generative adversarial network in accordance with one or more embodiments.

FIG. 8 illustrates a block diagram of an example computing device for implementing one or more embodiments of the present disclosure.

### DETAILED DESCRIPTION

This disclosure describes one or more embodiments of a domain gap generative adversarial system that trains and utilizes a domain gap generative adversarial network to denoise digital images. More specifically, in one or more embodiments, the domain gap generative adversarial system more accurately and efficiently denoises images by training a domain gap generative adversarial network utilizing a paired ground-truth dataset with synthetic noise and an unpaired ground-truth dataset with natural noise. To illustrate, in some embodiments, the domain gap generative adversarial system utilizes either a one-discriminator training pipeline or a two-discriminator training pipeline to discriminate between predicted denoised images for the digital images with synthetic noise, corresponding ground-truth digital images for the digital images with synthetic noise, and predicted denoised images for the digital images with natural noise. Accordingly, in one or more embodiments, the domain gap generative adversarial system improves performance of the domain gap generative adversarial network, especially for natural images with natural noise.

In one or more embodiments, the domain gap generative adversarial system trains a domain gap generative adversarial network utilizing two training datasets. More specifically, in some embodiments, the domain gap generative adversarial system generates a paired training dataset. To illustrate, in one or more embodiments the domain gap generative adversarial system adds synthetic noise to a set of clean digital images. Accordingly, in some embodiments, the domain gap generative adversarial system utilizes a training set of clean ground-truth digital images and corresponding digital images with synthetic noise. Further, in one or more embodiments, the domain gap generative adversarial system also utilizes an unpaired training dataset of digital images with natural noise.

In some embodiments, the domain gap generative adversarial system trains the domain gap generative adversarial network by utilizing both the paired training dataset and the unpaired dataset with an untrained domain gap generative adversarial network. More specifically, in one or more embodiments, the domain gap generative adversarial system determines and utilizes image loss, perceptual loss, and generative adversarial network loss for the paired dataset. Further, in some embodiments, the domain gap generative adversarial system determines and utilizes generative adversarial network loss for the unpaired dataset. Accordingly, in one or more embodiments, the domain gap generative adversarial system trains the domain gap generative adversarial system to denoise natural noise without introducing inaccuracies from simulating denoised natural noise using individually-generated digital image pairs.

In some embodiments, the domain gap generative adversarial system utilizes a domain gap generative adversarial network with one discriminator. In order to train a domain gap generative adversarial network with one discriminator, the domain gap generative adversarial system provides the paired dataset and the unpaired dataset to a generator of the domain gap generative adversarial network. Accordingly, in one or more embodiments, the generator determines predicted denoised images for digital images with synthetic noise and predicted denoised images for digital images with natural noise. Further, in one or more embodiments, the domain gap generative adversarial system determines image loss and perceptual loss for the predicted denoised images for digital images with synthetic noise utilizing the ground-truth digital images.

Additionally, the domain gap generative adversarial system provides the predicted denoised images for digital images with synthetic noise and the predicted denoised images for digital images with natural noise to a discriminator of the domain gap generative adversarial network. In one or more embodiments, the domain gap generative adversarial system receives natural logits from the discriminator based on the predicted denoised images for digital images with natural noise. Further, in some embodiments, the domain gap generative adversarial system receives synthetic logits based on the predicted digital images with synthetic noise. Accordingly, in one or more embodiments, the domain gap generative adversarial system utilizes the natural logits and the synthetic logits to determine a generative adversarial network loss. Thus, in one or more embodiments, the domain gap generative adversarial system utilizes the image loss, perceptual loss, and generative adversarial network loss to train the one-discriminator domain gap generative adversarial network.

In addition, or in the alternative, the domain gap generative adversarial system trains and utilizes a domain gap generative adversarial network with two discriminators. As described above with regard to the one-discriminator domain gap generative adversarial network, in some embodiments, the domain gap generative adversarial system determines image loss and perceptual loss for predicted digital images with synthetic loss relative to corresponding ground-truth digital images. Further, in one or more embodiments, the domain gap generative adversarial system utilizes a first discriminator to perform a discrimination utilizing ground-truth digital images and predicted digital images with synthetic noise. Additionally, in some embodiments, the domain gap generative adversarial system utilizes a second discriminator to determine a discrimination utilizing predicted digital images with synthetic noise and predicted digital images with natural noise. Accordingly, in one or more embodiments, the domain gap generative adversarial system determines a generative adversarial network loss based on both discriminations.

As suggested above, embodiments of the domain gap generative adversarial system provide certain improvements or advantages over conventional systems. More specifically, the training pipeline of the domain gap generative adversarial system bridges the domain gap between natural and synthetic noise. To illustrate, the domain gap generative adversarial system improves accuracy relative to conventional systems by generating clearer denoised images relative to conventional generative adversarial networks. For example, the domain gap generative adversarial system trains a neural network with improved accuracy over those trained using only digital images with synthetic noise. Specifically, by utilizing both a paired ground-truth dataset of digital images with synthetic noise and an unpaired dataset with natural noise, the domain gap generative adversarial system trains the domain gap generative adversarial network to more accurately process digital images with natural noise. Accordingly, the domain gap generative adversarial system improves the clarity of denoised images relative to conventional systems.

Additionally, the domain gap generative adversarial system improves accuracy relative to conventional generative adversarial networks that are trained utilizing individually-generated digital image pairs with natural noise. To illustrate, by utilizing both a paired ground-truth dataset of digital images with synthetic noise and an unpaired dataset with natural noise, the domain gap generative adversarial system reduces or eliminates inaccuracies caused by simulated natural noise image pairs. In one or more embodiments, the domain gap generative adversarial system determines generative adversarial network loss using both the paired ground-truth dataset of digital images with synthetic noise and the unpaired dataset with natural noise. Thus, the trained domain gap generative adversarial system improves the accuracy of denoised images relative to conventional generative adversarial networks.

The domain gap generative adversarial system also improves efficiency relative to conventional generative adversarial networks. Indeed, the domain gap generative adversarial system reduces or eliminates excess time and computing resources used in generating simulated digital image pairs with natural noise. In one or more embodiments, the domain gap generative adversarial system trains its domain gap generative adversarial network using digital images with natural noise without requiring use of simulated digital image pairs with natural noise. Accordingly, by avoiding the use of simulated digital image pairs with natural noise, the domain gap generative adversarial system conserves time and computing resources relative to conventional systems.

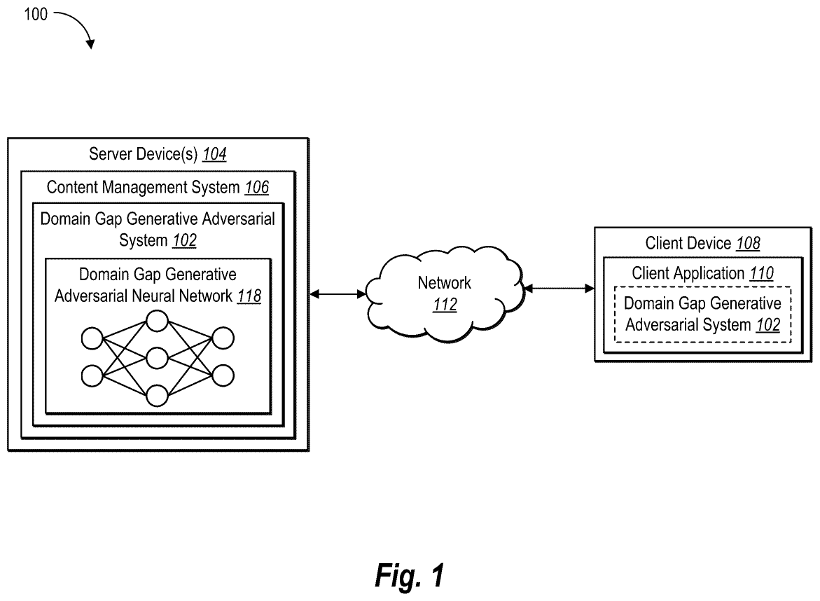

Additional detail regarding the domain gap generative adversarial system will now be provided with reference to the figures. For example, FIG. 1 illustrates a schematic diagram of an example system environment 100 for implementing a domain gap generative adversarial system 102 in accordance with one or more embodiments. An overview of the domain gap generative adversarial system 102 is described in relation to FIG. 1. Thereafter, a more detailed description of the components and processes of the domain gap generative adversarial system 102 is provided in relation to the subsequent figures.

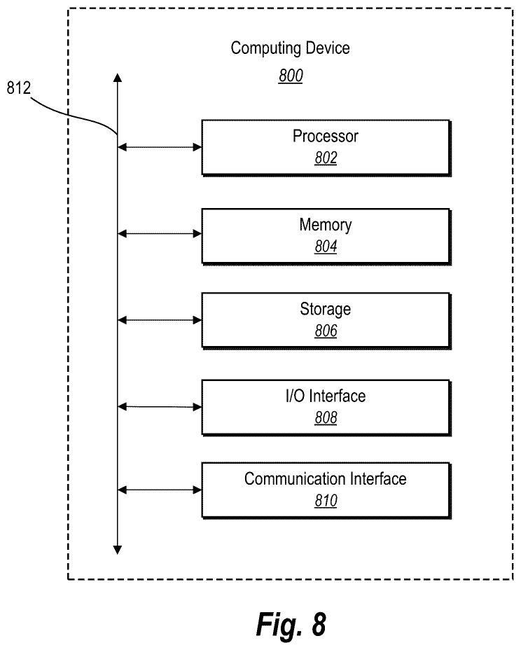

As shown, the environment includes server device(s) 104, a client device 108, and a network 112. Each of the components of the environment communicate via the network 112, and the network 112 is any suitable network over which computing devices communicate. Example networks are discussed in more detail below in relation to FIG. 8.

As mentioned, the environment includes a client device 108. The client device 108 is one of a variety of computing devices, including a smartphone, a tablet, a smart television, a desktop computer, a laptop computer, a virtual reality device, an augmented reality device, or another computing device as described in relation to FIG. 8. Although FIG. 1 illustrates a single instance of the client device 108, in some embodiments, the environment includes multiple different client devices, each associated with a different user. The client device 108 communicates with the server device(s) 104 and/or the content management system 106 via network 112. For example, the client device 108 receives information from the server device(s) 104 and provides information to server device(s) 104 relating to digital images.

As shown in FIG. 1, the client device 108 includes a client application 110. In particular, the client application 110 is a web application, a native application installed on the client device 108 (e.g., a mobile application or a desktop application), or a cloud-based application where all or part of the functionality is performed by the server device(s) 104. The client application 110 presents or displays information to a user, including a content editing interface for denoising a digital image. A denoised image or denoised digital image refers to a digital image that has had noise removed from it. In particular, the term denoised image can refer to a digital image that has had either natural or synthetic noise removed from it. In one or more embodiments, a denoised image includes an image that a domain gap generative adversarial network has removed noise from.

As also illustrated in FIG. 1, the environment includes the server device(s) 104. The server device(s) 104 generates, tracks, stores, processes, receives, and transmits electronic data, such as digital images, including digital images in training datasets. For example, the server device(s) 104 receives data from the client device 108 in the form of a digital image. In response, the server device(s) 104 provides data to the client device 108 in the form of a denoised digital image, as described herein. For example, the server device(s) 104 access a trained neural network, such as the domain gap generative adversarial neural network 118, to generate and provide the denoised digital image to the client device 108.

In some embodiments, the server device(s) 104 communicates with the client device 108 to transmit and/or receive data via the network 112. In some embodiments, the server device(s) 104 comprises a distributed server where the server device(s) 104 includes a number of server devices distributed across the network 112 and located in different physical locations. The server device(s) 104 comprise a content server, an application server, a communication server, a web-hosting server, a multidimensional server, or a machine learning server.

As further shown in FIG. 1, the server device(s) 104 also includes the domain gap generative adversarial system 102 as part of a content management system 106. For example, in one or more implementations, the content management system 106 stores, generates, modifies, edits, enhances, provides, distributes, and/or shares digital content, such as digital images. For example, the content management system 106 provides digital content for editing or other forms of digital processing. In some implementations, the content management system 106 provides digital content to particular digital profiles associated with client devices (e.g., the client device 108).

In one or more embodiments, the server device(s) 104 includes all, or a portion of, the domain gap generative adversarial system 102. For example, the domain gap generative adversarial system 102 operates on the server device(s) 104 to denoise digital images and/or train the domain gap generative adversarial neural network 118. In some embodiments, the client device 108 includes all or part of the domain gap generative adversarial system 102. Indeed, in some implementations, as illustrated in FIG. 1, the domain gap generative adversarial system 102 is located in whole or in part of the client device 108 (e.g., as part of the client application 110). For example, the domain gap generative adversarial system 102 includes a web hosting application that allows the client device 108 to interact with the server device(s) 104. To illustrate, in one or more implementations, the client device 108 accesses a web page supported and/or hosted by the server device(s) 104.

In one or more embodiments, the client device 108 and the server device(s) 104 work together to train and/or implement models of the domain gap generative adversarial system 102. For example, in some embodiments, the server device(s) 104 train one or more neural networks (e.g., the domain gap generative adversarial neural network 118) and provide the one or more neural networks to the client device 108 for implementation. In some embodiments, the server device(s) 104 trains one or more neural networks together with the client device 108.

Although FIG. 1 illustrates a particular arrangement of the environment, in some embodiments, the environment has a different arrangement of components and/or may have a different number or set of components altogether. For instance, as mentioned, the domain gap generative adversarial system 102 is implemented by (e.g., located entirely or in part on) the client device 108. As another example, the pixel window algorithm 116 and/or the domain gap generative adversarial neural network 118 are stored in the database 114. In addition, in one or more embodiments, the client device 108 communicates directly with the domain gap generative adversarial system 102, bypassing the network 112.

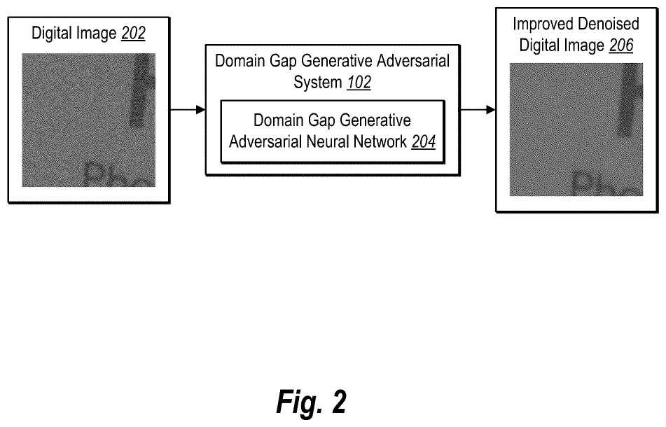

As discussed above, in one or more embodiments, the domain gap generative adversarial system 102 utilizes a domain gap generative adversarial network to denoise digital images. For instance, FIG. 2 illustrates the domain gap generative adversarial system 102 denoising a digital image 202 in accordance with one or mor embodiments. Specifically, FIG. 2 shows the domain gap generative adversarial system 102 receiving or accessing a digital image. In one or more embodiments, the domain gap generative adversarial system 102 receives or accesses the digital image from a client device, including via a content management system.

As shown in FIG. 2, the domain gap generative adversarial system 102 utilizes a machine learning model in the form of the domain gap generative adversarial network to denoise the digital image. A machine learning model refers to a computer algorithm or a collection of computer algorithms that automatically improve for a particular task through iterative outputs or predictions based on use of data. For example, a machine learning model utilizes one or more learning techniques to improve in accuracy and/or effectiveness. Example machine learning models include various types of neural networks, generative adversarial networks, decision trees, support vector machines, linear regression models, and Bayesian networks. In some embodiments, the customized follow-up survey system utilizes a large language machine learning model in the form of a neural network.

Along these lines, a neural network refers to a machine learning model that is trained and/or tuned based on inputs to generate digital content such as text and images, and to determine classifications, scores, or approximate unknown functions. For example, a neural network includes a model of interconnected artificial neurons (e.g., organized in layers) that communicate and learn to approximate complex functions and generate outputs (e.g., information flow patterns) based on a plurality of inputs provided to the neural network. In some cases, a neural network refers to an algorithm (or set of algorithms) that implements deep learning techniques to model high-level abstractions in data. In some embodiments, a neural network includes various layers such as an input layer, one or more hidden layers, and an output layer that each perform tasks for processing data. For example, a neural network includes a deep neural network, a convolutional neural network, a recurrent neural network (e.g., an LSTM), a graph neural network, a transformer neural network, a diffusion neural network, a generative adversarial neural network, or a large language model.

Further, a generative adversarial network refers to a generative neural network trained to generate new data with the same statistics as a training set of data. More specifically, in one or more embodiments, a generative adversarial network refers to a neural network trained utilizing indirect training through a discriminator and facilitating a contest between two neural networks in a zero-sum game. Relatedly, a domain gap generative adversarial network refers to a generative adversarial network trained utilizing both (1) a paired training dataset of clean, non-noisy digital images and corresponding digital images with synthetic noise, and (2) an unpaired training dataset of digital images with natural noise.

In one or more embodiments, the domain gap generative adversarial network has improved performance because its training bridges the domain gap between natural noise and synthetic noise in digital images. To illustrate, generative adversarial network models minimize a loss function that classifies digital images as genuine or artificial. Given a training dataset, a generative adversarial network attempts to generate new output that has the same characteristics as the training dataset.

A training dataset refers to a set of examples utilized to train a model in a machine learning process. In particular, the term training dataset can refer to images, text, or other media utilized to train a machine learning model. A paired training dataset refers to a dataset that includes ground-truth data. For example, a paired training dataset can refer to a dataset of clean non-noisy digital images and corresponding digital images with synthetic noise. Relatedly, an unpaired training dataset can refer to a dataset that does not include corresponding ground-truth information. For example, an unpaired training dataset can include a set of digital images with natural noise.

Relatedly, used herein, natural noise refers to genuine variations in a digital image produced by an image sensor when capturing or detecting photons in the digital image. In particular, the term natural noise refers to variations of brightness, color information, or other naturally-occurring electronic noise captured when generating a digital image. Natural noise does not refer to synthetic noise or artificial noise added to a digital image.

For example, in one or more embodiments, a generative adversarial network utilizes a dataset of clean images and corresponding images with synthetic noise. Some generative adversarial networks add the noise to the corresponding images with synthetic noise. To illustrate, some generative adversarial networks take the clean digital image as y, the digital image with synthetic noise as x, and the synthetic noise as ε, such that x=y+ε. Further, some generative adversarial networks utilize the synthetic noisy image x into a generator G_{θ} of the generative adversarial network to generate a synthetic denoised image \acute{x}=G_{θ}(x). Accordingly, some generative adversarial networks utilize the clean image y and the synthetic denoised image \acute{x} to a discriminator D_{φ} to produce ground-truth logits D_{φ}(y) and synthetic denoised image logits D_{φ}(\acute{x}). Accordingly, many generative adversarial networks utilize Algorithm 1 to determine generative adversarial network loss, where dis denotes the U-net based discriminator for the generative adversarial neural network.

Algorithm 1

```
if Generator then
  dis(\acute{x}) → 1
else {Discriminator}
  dis(\acute{x}) → 0
  dis(y) → 1
end if
```

Thus, for many generative adversarial networks, the input for the generator is synthetic data. To illustrate, for many generative adversarial networks, training involves comparing logits for clean images to logits from predicted denoised images with synthetic noise. Accordingly, many generative adversarial networks have a domain gap between the training data and testing.

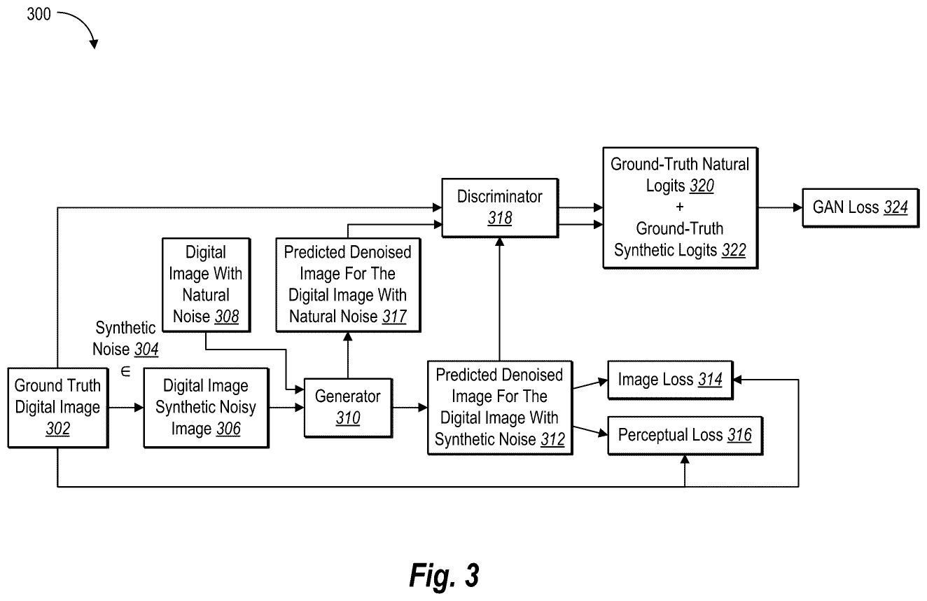

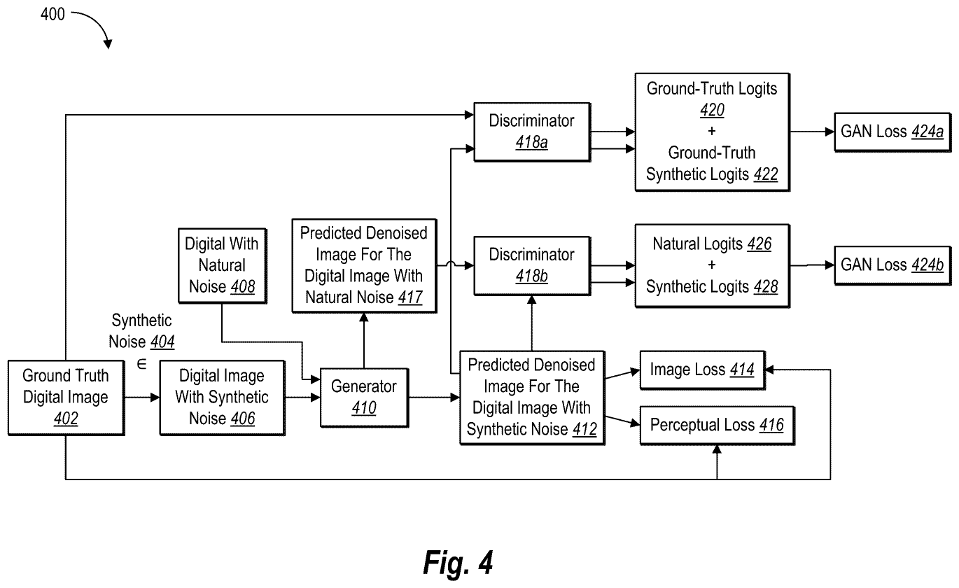

However, as will be discussed below with regard to FIGS. 3-4, the domain gap generative adversarial network bridges this domain gap by introducing an additional data stream of images with natural noise to the training process. Specifically, in one or more embodiments, the domain gap generative adversarial system 102 utilizes both (1) a paired training dataset of clean, non-noisy digital images and corresponding digital images with synthetic noise, and (2) an unpaired training dataset of digital images with natural noise. Thus, in some embodiments, the domain gap generative adversarial system 102 applies a discriminator to the predicted denoised images for the digital images with natural noise and the predicted denoised images for the digital images with synthetic noise. Accordingly, the domain gap generative adversarial network 204 generates an improved denoised digital image relative to conventional systems. More specifically, in one or more embodiments, the domain gap generative adversarial system 102 trains a generator on the paired dataset utilizing one or more losses. A loss refers to a value representing an amount of error or a degree to which an algorithm correctly models a dataset. In one or more embodiments, image loss refers to a least absolute deviations loss for a digital image. In addition, or in the alternative, image loss refers to another loss, such as a least square errors loss. Further, perceptual loss refers to a measure of the high-level features of two images. Additionally, generative adversarial network loss refers to a value determined by a discriminator of level of accuracy of a predicted machine learning output. In one or more embodiments, the domain gap generative adversarial system 102 trains a generator utilizing an image loss, perceptual loss, and generative adversarial network loss. Further, the domain gap generative adversarial system 102 trains the generator on generative adversarial loss from the unpaired dataset of digital images with natural noise.

As mentioned above, in one or more embodiments, the domain gap generative adversarial system 102 utilizes a one-discriminator training pipeline to train the domain gap generative adversarial network. FIG. 3 illustrates a process 300 for training a domain gap generative adversarial network utilizing a single discriminator. As shown in FIG. 3, the domain gap generative adversarial system 102 utilizes a ground truth digital image 302 and introduces synthetic noise 304 to generate a digital image with synthetic noise 306. To illustrate, in one or more embodiments, the domain gap generative adversarial system 102 takes the clean digital image as y, the digital image with synthetic noise as x, and the synthetic noise as ε, such that x=y+ε.

Further, as shown in FIG. 3, the domain gap generative adversarial system 102 utilizes a generator 310 to generate predicted denoised images. Specifically, the generator 310 generates a predicted denoised image for the digital image with synthetic noise 312 based on the digital image with synthetic noise 306. Further, the generator 310 generates a predicted denoised image for the digital image with natural noise 317 based on the digital image with natural noise 308.

Additionally, as shown in FIG. 3, the domain gap generative adversarial system 102 determines image loss 314 and perceptual loss 316 based on the ground truth digital image 302 and the predicted denoised image for the digital image with synthetic noise 312. In one or more embodiments, the domain gap generative adversarial system 102 determines perceptual loss as the difference between the high-level features of the ground truth digital image 302 and the predicted denoised image for the digital image with synthetic noise 312. More specifically, in one or more embodiments, the domain gap generative adversarial system 102 determines the perceptual loss 316 utilizing a perceptual loss function. In some embodiments, the perceptual loss function utilizes content loss that measures overall difference between the feature maps two images. Further, in one or more embodiments, the perceptual loss function also utilizes a style loss that measures the difference in correlation of texture and style between feature maps of two images.

Further, in one or more embodiments, the domain gap generative adversarial system 102 determines image loss 314. To illustrate, in some embodiments, the domain gap generative adversarial system 102 determines the image loss as a value representing an amount of error between two images. For example, in one or more embodiments, the domain gap generative adversarial system 102 determines image loss as a degree to which the ground truth digital image 302 and the predicted denoised image for the digital image with synthetic noise 312 deviate. In one or more embodiments, the domain gap generative adversarial system 102 utilizes L1 loss that measures a least absolute deviations loss for between digital images. In addition, or in the alternative, the domain gap generative adversarial system 102 utilizes L2 loss that measures as a least square errors loss between digital images.

As also shown in FIG. 3, the domain gap generative adversarial system 102 utilizes the discriminator 318 to discriminate between the ground truth digital image 302, the predicted denoised image for the digital image with synthetic noise, and the predicted denoised image for the digital image with natural noise 417. More specifically, in one or more embodiments, the domain gap generative adversarial system 102 utilizes the discriminator 318 to generate a first discrimination between the ground-truth digital images for the digital images with synthetic noise and the predicted denoised images for the digital images with synthetic noise. Further, in some embodiments, the domain gap generative adversarial system 102 utilizes the discriminator 318 to generate a second discrimination between the predicted denoised images for the digital images with natural noise and the predicted denoised images for the digital images with synthetic noise.

As shown in FIG. 3, the domain gap generative adversarial system 102 utilizes the discriminator 318 to generate ground-truth natural logits 320 and ground-truth synthetic logits 322. A logit refers to a probability value from a log-odds function. In particular, a logit includes probability or error values generated by a discriminator. Specifically, a ground-truth synthetic logit refers to logits determined utilizing ground-truth digital images for the digital images with synthetic noise and the predicted denoised images for the digital images with synthetic noise. Further, a ground-truth natural logit refers to logits determined utilizing the predicted denoised images for the digital images with natural noise and the predicted denoised images for the digital images with synthetic noise. Additionally, a synthetic logit refers to logits determined based on the predicted denoised images for the digital images with natural noise. Further, a natural logit refers to logits determined based on the predicted digital images for the digital images with synthetic noise.

To illustrate, in one or more embodiments, the domain gap generative adversarial system 102 utilizes a first discrimination to determine the ground-truth synthetic logits 322 based on the ground truth digital image 302 and the predicted denoised images for the digital images with synthetic noise 312. Further, in some embodiments, the domain gap generative adversarial system 102 utilizes a second discrimination to determine ground-truth natural logits 320 based on the predicted denoised image for the digital images with natural noise 317 and the predicted denoised image for the digital images with synthetic noise 312.

Further, as shown in FIG. 3, the domain gap generative adversarial system 102 utilizes the ground-truth natural logits 320 and ground-truth synthetic logits 322 to determine a generative adversarial network loss 324. More specifically, in one or more embodiments, the domain gap generative adversarial system 102 applies a generative adversarial network loss algorithm to the ground-truth synthetic logits 322 and the ground-truth natural logits 320 to determine the generative adversarial network loss 324. In one or more embodiments, the domain gap generative adversarial system 102 utilizes Algorithm 2 to determine the generative adversarial network loss for a one-discriminator training pipeline. Additionally, in one or more embodiments, the domain gap generative adversarial system 102 adds an R1 regularization to the generative adversarial network loss 324.

In one or more embodiments, the domain gap generative adversarial system 102 utilizes the generative adversarial network loss 324, the image loss 314, and the perceptual loss 316 to train the domain gap generative adversarial network. To illustrate, the domain gap generative adversarial system 102 iteratively trains the domain gap generative adversarial network by modifying parameters of the domain gap generative adversarial network based on these loss values. Accordingly, in one or more embodiments, the domain gap generative adversarial system 102 utilizes the discriminations to modify network parameters.

To illustrate, in one or more embodiments, where the digital image with natural noise is z, the digital image with synthetic noise is x, the generator is G_{θ}, the predicted denoised image with synthetic noise is \acute{x}=G_{θ}(x), the predicted denoised image with natural noise is ź=G_{θ}(z), the discriminator is D_{φ}, the ground-truth natural logits are D_{φ}(ź), and the ground-truth synthetic logits are D_{φ}(\acute{x}), the domain gap generative adversarial system 102 utilizes the following Equation 1 and Algorithm 2 for a one-discriminator domain gap generative adversarial network.

$${min}_{G} {max}_{D} V ( D , G ) = {E}_{x} [ log D ( x ) ] + {E}_{z} [ log ( 1 - D ( G ( z ) ) ] . \qquad ( 1 )$$

Algorithm 2 One-Discriminator Domain
Gap Generative Adversarial Network

```
if Generator then
  dis(\acute{x}) → 1
  dis(ź) → 1
else {Discriminator}
  dis(\acute{x}) → 0
  dis(ź) → 0
  dis(y) → 1
end if
```

As mentioned above, in one or more embodiments, the domain gap generative adversarial system 102 also utilizes a two-discriminator domain gap generative adversarial network. FIG. 4 illustrates a process 400 for training a domain gap generative adversarial network with two discriminators. In one or more embodiments, the domain gap generative adversarial system 102 improves efficiency by splitting the burden of discrimination across two discriminators. To illustrate, as shown in FIG. 4, the domain gap generative adversarial system 102 utilizes a ground truth digital image 402 and introduces synthetic noise 404 to generate a digital image with synthetic noise 406. Similar to the discussion above with regard to FIG. 3, in one or more embodiments, the domain gap generative adversarial system 102 takes the clean digital image as y, the digital image with synthetic noise as x, and the synthetic noise as ε, such that x=y+ε.

Further, as shown in FIG. 4, the domain gap generative adversarial system 102 utilizes a generator 410 to generate predicted denoised images from a digital image with synthetic noise 406 and a digital image with natural noise 408. Specifically, the generator 410 generates a predicted denoised image for the digital image with synthetic noise 412 based on the digital image with synthetic noise 406. Further, the generator 410 generates a predicted denoised image for the digital image with natural noise 417 based on the digital image with natural noise 408.

As also discussed above with regard to FIG. 3, the domain gap generative adversarial system 102 determines image loss and perceptual loss based on the predicted denoised image for the digital image with synthetic noise 412 and corresponding the ground truth digital image 402. To illustrate, in some embodiments, the domain gap generative adversarial system 102 determines perceptual loss by determining the difference between the high-level features of two digital images. Further, in one or more embodiments, the domain gap generative adversarial system 102 determines the perceptual loss by determining a loss value representing an amount of error between two images.

As also shown in FIG. 4, the domain gap generative adversarial system 102 provides the predicted denoised image for the digital image with synthetic noise 412 and the ground truth digital image 402 to the discriminator 418a. Further, as shown in FIG. 4, the discriminator 418a generates the ground-truth logits 420 based on the ground truth digital image 402. Additionally, the discriminator 418a generates the ground-truth synthetic logits based on the predicted denoised image for the digital image with synthetic noise 412. Additionally, as shown in FIG. 4, the domain gap generative adversarial system 102 utilizes the ground-truth logits 420 and the ground-truth synthetic logits to determine a generative adversarial network loss 424a. Further, in one or more embodiments, the domain gap generative adversarial system 102 adds an R1 regularization to the generative adversarial network loss 424a

Additionally, as shown in FIG. 4, the domain gap generative adversarial system 102 provides the predicted denoised image for the digital image with synthetic noise 412 and the predicted denoised image for the digital image with natural noise 417 to the discriminator 418b. Accordingly, the discriminator 418b generates natural logits 426 based on the predicted digital images for the digital images with natural noise 417. Additionally, the discriminator 418b generates the synthetic logits 428 based on the predicted denoised images for the digital images with synthetic noise 412. Further, as shown in FIG. 4, the domain gap generative adversarial system 102 utilizes the natural logits 426 and the synthetic logits 428 to determine a generative adversarial network loss 424b. Additionally, in one or more embodiments, the domain gap generative adversarial system 102 adds an R1 regularization to the generative adversarial network loss 424b.

In one or more embodiments, the domain gap generative adversarial system 102 modifies parameters of the two-discriminator domain gap generative adversarial network utilizing the generative adversarial network loss 424a, the generative adversarial network loss 424b, the image loss 414, and the perceptual loss 416. Accordingly, in some embodiments, the domain gap generative adversarial system 102 trains the domain gap generative adversarial network based on generative adversarial network losses from the two different discriminators. Thus, the domain gap generative adversarial system 102 utilizes both (1) generative adversarial loss from a paired dataset of digital images with synthetic noise and (2) generative adversarial loss from an unpaired dataset of digital images with natural noise.

To illustrate, in one or more embodiments, where the digital image with natural noise is z, the digital image with synthetic noise is x, the generator is G_{θ}, the predicted denoised image with synthetic noise is \acute{x}=G_{θ}(x), the predicted denoised image with natural noise is ź=G_{θ}(z), the first discriminator is D_{φ}, the second discriminator is discriminator is D′_{φ}, the ground-truth natural logits are D_{φ}(ź), the ground-truth synthetic logits are D_{φ}(\acute{x}), the natural logits are D′_{φ}(ź), and the synthetic logits are D′_{φ}(\acute{x}) the domain gap generative adversarial system 102 utilizes the following Algorithm 3 for a two-discriminator domain gap generative adversarial network. In one or more embodiments, the domain gap generative adversarial system 102 also uses Equation 1 for a two-discriminator domain gap generative adversarial network.

Algorithm 3 Two-Discriminator Domain
Gap Generative Adversarial Network

```
if Generator then
  dis(\acute{x}) → 1
  dis(ź) → 1
else {Discriminator}
  dis(\acute{x}) → 0
  dis(ź) → 0
  dis(y) → 1
end if
```

In one or more embodiments, the domain gap generative adversarial system 102 utilizes a Scunet generator. To illustrate, in some embodiments, the domain gap generative adversarial system 102 utilizes a swin-conv block to incorporate the local modeling ability of residual convolutional layer and non-local modeling ability of a swin transformer block. Further, in one or more embodiments, the domain gap generative adversarial system 102 utilizes the generator as part of an image-to-image translation UNet architecture. In some embodiments, the domain gap generative adversarial network applies one Swin-Convolution block for each intermediate module in the U-net. Additionally, in one or more embodiments, the domain gap generative adversarial system 102 applies one convolution layer as input preprocessor and one pixel shuffle upsampler after the output layer of Scunet.

Additionally, in some embodiments, the domain gap generative adversarial system 102 utilizes a Unet-based discriminator. More specifically, in one or more embodiments, the domain gap generative adversarial system 102 utilizes a Unet designed model with skip connections. Accordingly, in some embodiments, the domain gap generative adversarial system 102 utilizes a Unet-based discriminator that outputs realness values for each pixel, and that provides detailed per-pixel feedback to the generator. Further, in one or more embodiments, the domain gap generative adversarial system 102 utilizes spectral normalization regulation to stabilize the training dynamics and alleviate over-sharpness or artifacts introduced during the generative adversarial network training process.

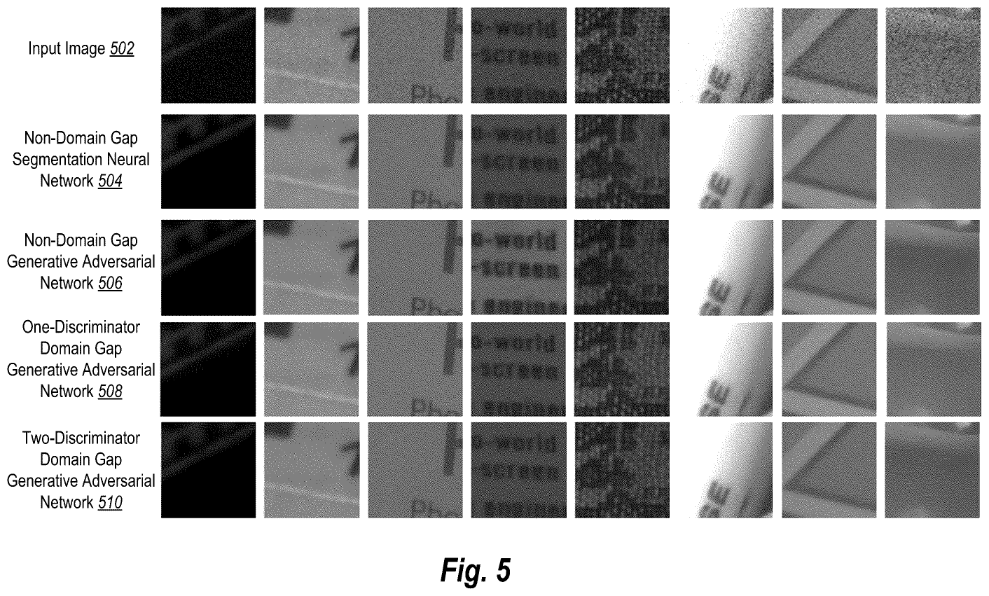

The domain gap generative adversarial network improves performance over other generative adversarial networks. FIG. 5 illustrates qualitative data showing the improved clarity of denoised digital images generated by a domain gap generative adversarial network. More specifically, column 502 shows input images, column 504 shows denoised digital images from a non-domain gap segmentation neural network, column 506 shows denoised digital images from a non-domain gap generative adversarial neural network, column 508 shows denoised digital images from a one-discriminator domain gap generative adversarial network, and column 510 shows denoised digital images from a two-discriminator domain gap generative adversarial network.

In an experiment for which these different networks denoised digital images from the same dataset. Further, for synthetic noise, the domain gap generative adversarial system 102 utilized the 3D generalized zero-mean Gaussian noise model with a 3×3 covariance matrix to model the noise correlation between R, G, and B channels. For this experiment, the domain gap generative adversarial system 102 sampled two extreme cases with color and grayscale noise and general cases with probabilities 0.4, 0.4, and 0.2, respectively. After application of the Gaussian noise model, the domain gap generative adversarial system 102 also applied Poisson noise. To illustrate, the domain gap generative adversarial system 102 sampled grayscale Poisson noise with probability 0.5. The domain gap generative adversarial system 102 further applied Speckle noise and JPEG compression noise.

For the unpaired dataset of digital images with natural noise, the domain gap generative adversarial system 102 utilized a dataset of approximately 30,000 noisy images from ten scenes under different lighting conditions using five representative smartphone cameras. The training set patch size is set to 256. The domain gap generative adversarial system 102 utilized a total batch size of eight.

Additionally, the domain gap generative adversarial system 102 optimized parameters by minimizing L1 image loss with an Adam optimizer. Further, the domain gap generative adversarial system 102 utilized a learning rate starting at 1e⁻⁴ and decaying by a factor of 0.999 using Exponential Learning Rate scheduler. For this experiment, the domain gap generative adversarial system 102 trained the domain gap generative adversarial network for 1,000,000 iterations. Further, the domain gap generative adversarial system 102 adopted exponential moving average for more stable training and better performance. In addition, for the experiment, the domain gap generative adversarial system 102 trained the domain gap generative adversarial networks with a combination of image loss, perceptual loss, and generative adversarial network loss at weights of 1, 1, and 0.1, respectively, Further, the domain gap generative adversarial system 102 utilized the conv1, . . . conv5 feature maps with weights 0.1, 0.1, 1, 1, and 1, respectively, before activation in a pre-trained network as the perceptual loss.

Table 1 below shows quantitative results of the experiment.

| Methods | PSNR(dB) |
|---|---|
| Non-Domain Gap Segmentation Neural Network | 30.44 |
| Non-Domain Gap Generative Adversarial Network | 31.13 |
| One-Discriminator Domain Gap Generative Adversarial | 32.81 |
| Network | |
| One-Discriminator Domain Gap Generative Adversarial | 33.05 |
| Network + EMA | |
| Two-Discriminator Domain Gap Generative Adversarial | 31.92 |
| Network | |
| Two-Discriminator Domain Gap Generative Adversarial | 32.46 |
| Network + EMA | |

As shown in Table 1, all implementations of the one-discriminator domain gap generative adversarial network and the two-discriminator domain gap generative adversarial network both perform better than a non-domain gap generative adversarial network or a non-domain gap segmentation neural network. Additionally, exponential moving average improves the performance of both the one-discriminator domain gap generative adversarial network and the two-discriminator domain gap generative adversarial network. More specifically, the two-discriminator domain gap generative adversarial network performs 0.9% worse than the one-discriminator domain gap generative adversarial network, but better than a non-domain gap generative adversarial network.

Further, FIG. 5 shows the qualitative results of the experiment. Qualitatively, the two-discriminator domain gap generative adversarial network generates the clearest denoised digital images. Additionally, both the two-discriminator domain gap generative adversarial network and the one-discriminator domain gap generative adversarial network qualitatively outperform the non-domain gap segmentation neural network and the non-domain gap generative adversarial neural network. Accordingly, the domain gap generative adversarial system 102 improves the quality of denoised digital image in real conditions.

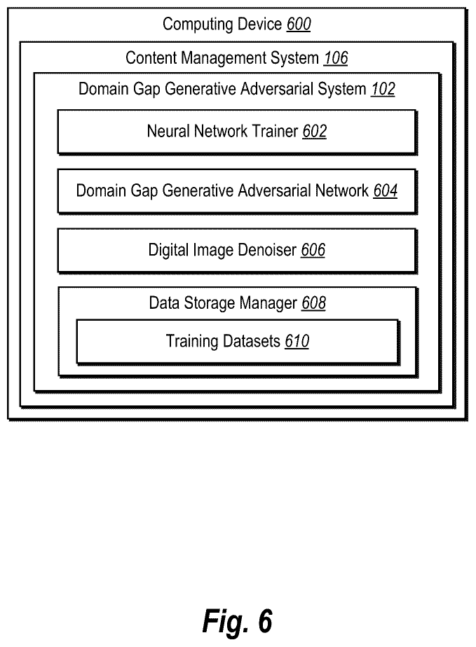

Looking now to FIG. 6, additional detail will be provided regarding components and capabilities of the domain gap generative adversarial system 102. Specifically, FIG. 6 illustrates an example schematic diagram of the domain gap generative adversarial system 102 on an example computing device 600 (e.g., one or more of the client device 108 and/or the server device(s) 104). In some embodiments, the computing device 600 refers to a distributed computing system where different managers are located on different devices, as described above. As shown in FIG. 6, the domain gap generative adversarial system 102 includes a neural network trainer 602, a domain gap generative adversarial network 604, a digital image denoiser 606, and a data storage manager 608.

Each of the components 602-608 of the domain gap generative adversarial system 102 can include software, hardware, or both. For example, the components 602-608 can include one or more instructions stored on a computer-readable storage medium and executable by processors of one or more computing devices, such as a client device or server device. When executed by the one or more processors, the computer-executable instructions of the domain gap generative adversarial system 102 can cause the computing device(s) to perform the methods described herein. Alternatively, the components 602-608 can include hardware, such as a special-purpose processing device to perform a certain function or group of functions. Alternatively, the components 602-608 of the domain gap generative adversarial system 102 can include a combination of computer-executable instructions and hardware.

Furthermore, the components 602-608 of the domain gap generative adversarial system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 602-608 may be implemented as a stand-alone application, such as a desktop or mobile application. Furthermore, the components 602-608 may be implemented as one or more web-based applications hosted on a remote server. The components 602-608 may also be implemented in a suite of mobile device applications or “apps.”

As shown in FIG. 6, the domain gap generative adversarial system 102 includes the neural network trainer 602. In one or more embodiments, the neural network trainer 602 trains neural networks, including a domain gap generative adversarial network. In some embodiments, the neural network trainer 602 trains a domain gap generative adversarial network utilizing a paired training dataset of clean images and corresponding images with synthetic noise and an unpaired training dataset of images with natural noise.

Additionally, as shown in FIG. 6, the domain gap generative adversarial system 102 includes the domain gap generative adversarial network 604. In one or more embodiments, the domain gap generative adversarial network denoises digital images. In some embodiments, the domain gap generative adversarial network is trained via a one-discriminator training pipeline. In addition, or in the alternative, the domain gap generative adversarial network is trained via a two-discriminator training pipeline.

Further, as shown in FIG. 6, the domain gap generative adversarial system 102 includes the digital image denoiser 606. In one or more embodiments, the digital image denoiser 606 includes the domain gap generative adversarial network 604. In some embodiments, the digital image denoiser 606 manages inputs and outputs to and from the digital image denoiser 606.

The domain gap generative adversarial system 102 further includes a data storage manager 608. The data storage manager 608 operates in conjunction with, or includes, one or more memory devices such as a database that store various data such as digital images, such as training datasets 610. As shown, the data storage manager 608 stores the training datasets 610 accessible and usable by other components of the domain gap generative adversarial system 102. In some cases, the data storage manager 608 also stores the domain gap generative adversarial network 604 accessible and usable by other components of the domain gap generative adversarial system 102. The data storage manager 608 communicates with the other components of the domain gap generative adversarial system 102 to facilitate the operations and functions described herein.

Furthermore, the components of the domain gap generative adversarial system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the domain gap generative adversarial system 102 may be implemented as part of a stand-alone application on a personal computing device or a mobile device. Alternatively, or additionally, the components of the domain gap generative adversarial system 102 may be implemented in any application that allows creation and delivery of marketing content to users, including, but not limited to, applications in ADOBE® EXPERIENCE MANAGER and CREATIVE CLOUD®, such as ADOBE® PHOTOSHOP®, ILLUSTRATOR®, and INDESIGN®. “ADOBE,” “ADOBE EXPERIENCE MANAGER,” “CREATIVE CLOUD,” “PHOTOSHOP,” “ILLUSTRATOR,” and “INDESIGN” are either registered trademarks or trademarks of Adobe Inc. in the United States and/or other countries.

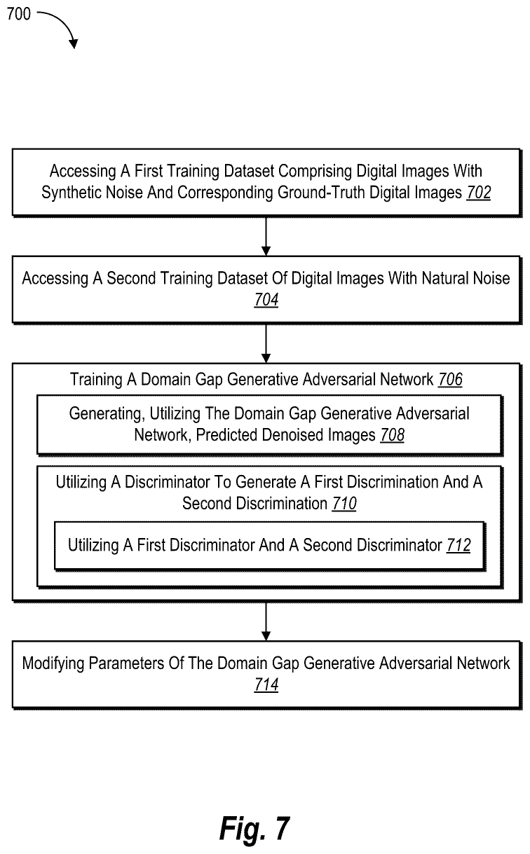

FIGS. 1-6, the corresponding text, and the examples provide a number of different methods, systems, devices, and non-transitory computer-readable media of the domain gap generative adversarial system 102. In addition to the foregoing, one or more embodiments can also be described in terms of flowcharts comprising acts for accomplishing a particular result, as shown in FIG. 7. FIG. 7 may be performed with more or fewer acts. Further, the acts may be performed in differing orders. Additionally, the acts described herein may be repeated or performed in parallel with one another or parallel with different instances of the same or similar acts.

As mentioned, FIG. 7 illustrates a flowchart of a series of acts 700 for training a domain gap generative adversarial network in accordance with one or more embodiments. While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer-readable medium can comprise instructions that, when executed by one or more processors, cause a computing device to perform the acts of FIG. 7. In some embodiments, a system can perform the acts of FIG. 7.

As shown in FIG. 7, the series of acts 700 includes an act 702 for accessing a first training dataset comprising digital images with synthetic noise and corresponding ground-truth digital images. Additionally, the series of acts 700 includes an act 704 for accessing a second training dataset of digital images with natural noise. Further, the series of acts 700 includes an act 706 for training a domain gap generative adversarial network. The act 706 can further include an act 708 for generating, utilizing the domain gap generative adversarial network, predicted denoised images. Further, the act 706 can include an act 710 for utilizing a discriminator to generate a first discrimination and a second discrimination. In one or more embodiments, the act 710 also includes an act 712 of utilizing a first discriminator and a second discriminator. Additionally, in one or more embodiments, the series of acts 700 includes an act 714 of modifying parameters of the domain gap generative adversarial network.

Additionally, in one or more embodiments, the series of acts 700 includes accessing a first training dataset comprising digital images with synthetic noise and corresponding ground-truth digital images for the digital images with synthetic noise. Further, in some embodiments, the series of acts 700 include accessing a second training dataset comprising digital images with natural noise. Additionally, in one or more embodiments, the series of acts 700 includes training a domain gap generative adversarial network by generating, utilizing the domain gap generative adversarial network, predicted denoised images from the digital images with synthetic noise and predicted denoised images from the digital images with natural noise and utilizing a discriminator to generate a first discrimination between the ground-truth digital images for the digital images with synthetic noise and the predicted denoised images for the digital images with synthetic noise, and a second discrimination between the predicted denoised images for the digital images with natural noise and the predicted denoised images for the digital images with synthetic noise. In one or more embodiments, the series of acts 700 also includes modifying parameters of the domain gap generative adversarial network based on the first discrimination and the second discrimination.

Further, in some embodiments, the series of acts 700 includes generating, utilizing the domain gap generative adversarial network, predicted denoised images from the digital images with synthetic noise and predicted denoised images from the digital images with natural noise. In one or more embodiments, the series of acts 700 also includes generating, utilizing a first discriminator, a first discrimination between the ground-truth digital images for the digital images with synthetic noise and the predicted denoised images for the digital images with synthetic noise. Further, in some embodiments, the series of acts 700 includes generating, utilizing a second discriminator, a second discrimination between the ground-truth digital images for the digital images with synthetic noise and the predicted denoised images for the digital images with natural noise.

In one or more embodiments, the series of acts 700 further includes determining image loss and perceptual loss for predicted denoised images for the digital images with synthetic noise, and modifying the parameters of the domain gap generative adversarial network further based on the image loss and the perceptual loss. In some embodiments, the series of acts 700 also includes utilizing the first discrimination and the second discrimination to determine generative adversarial network loss, and modifying the parameters of the domain gap generative adversarial network further based on the generative adversarial network loss.

Additionally, in some embodiments, the series of acts 700 includes utilizing the first discrimination to determine ground-truth synthetic logits based on the ground-truth digital images for the digital images with synthetic noise and the predicted denoised images for the digital images with synthetic noise, utilizing the second discrimination to determine ground-truth natural logits based on the predicted denoised images for the digital images with natural noise and the predicted denoised images for the digital images with synthetic noise, and applying a generative adversarial network loss algorithm to the ground-truth synthetic logits and the ground-truth natural logits to determine generative adversarial network loss.

In one or more embodiments, the series of acts 700 further includes utilizing a first discriminator to generate the first discrimination between the ground-truth digital images for the digital images with synthetic noise and the predicted denoised images for the digital images with synthetic noise, and utilizing a second discriminator to generate the second discrimination between the predicted denoised images for the digital images with natural noise and the predicted denoised images for the digital images with synthetic noise.

In some embodiments, the series of acts 700 also includes generating, utilizing a trained domain gap generative adversarial network, a denoised digital image based on a digital image with natural noise. Additionally, in one or more embodiments, the series of acts 700 also includes generating the first training dataset by adding synthetic noise to a set of digital images.

Further, in one or more embodiments, the series of acts 700 includes utilizing the first discriminator to determine ground-truth logits based on the ground-truth digital images for the digital images with synthetic noise, utilizing the first discriminator to determine ground-truth synthetic logits based on the predicted denoised images for the digital images with synthetic noise, and applying a generative adversarial network loss algorithm to the ground-truth logits and the ground-truth synthetic logits to determine generative adversarial network loss.

Additionally, in some embodiments, the series of acts 700 includes utilizing the second discriminator to determine natural logits based on the predicted digital images for the digital images with synthetic noise, utilizing the second discriminator to determine synthetic logits based on the predicted denoised images for the digital images with natural noise, and applying the generative adversarial network loss algorithm to the synthetic logits and the natural logits to determine the generative adversarial network loss.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates a block diagram of an example computing device 800 that may be configured to perform one or more of the processes described above. One will appreciate that one or more computing devices, such as the computing device 800 may represent the computing devices described above (e.g., the server device(s) 104 and/or the client device 108). In one or more embodiments, the computing device 800 may be a mobile device (e.g., a mobile telephone, a smartphone, a PDA, a tablet, a laptop, a camera, a tracker, a watch, a wearable device). In some embodiments, the computing device 800 may be a non-mobile device (e.g., a desktop computer or another type of client device). Further, the computing device 800 may be a server device that includes cloud-based processing and storage capabilities.

As shown in FIG. 8, the computing device 800 can include one or more processor(s) 802, memory 804, a storage device 806, input/output interfaces 808 (or “I/O interfaces 808”), and a communication interface 810, which may be communicatively coupled by way of a communication infrastructure (e.g., bus 812). While the computing device 800 is shown in FIG. 8, the components illustrated in FIG. 8 are not intended to be limiting. Additional or alternative components may be used in other embodiments. Furthermore, in certain embodiments, the computing device 800 includes fewer components than those shown in FIG. 8. Components of the computing device 800 shown in FIG. 8 will now be described in additional detail.

In particular embodiments, the processor(s) 802 includes hardware for executing instructions, such as those making up a computer program. As an example, and not by way of limitation, to execute instructions, the processor(s) 802 may retrieve (or fetch) the instructions from an internal register, an internal cache, memory 804, or a storage device 806 and decode and execute them.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 804 may be internal or distributed memory.

The computing device 800 includes a storage device 806 including storage for storing data or instructions. As an example, and not by way of limitation, the storage device 806 can include a non-transitory storage medium described above. The storage device 806 may include a hard disk drive (HDD), flash memory, a Universal Serial Bus (USB) drive or a combination these or other storage devices.

As shown, the computing device 800 includes one or more I/O interfaces 808, which are provided to allow a user to provide input to (such as user strokes), receive output from, and otherwise transfer data to and from the computing device 800. These I/O interfaces 808 may include a mouse, keypad or a keyboard, a touch screen, camera, optical scanner, network interface, modem, other known I/O devices or a combination of such I/O interfaces 808. The touch screen may be activated with a stylus or a finger.

The I/O interfaces 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 808 are configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 provides one or more interfaces for communication (such as, for example, packet-based communication) between the computing device and one or more other computing devices or one or more networks. As an example, and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI. The computing device 800 can further include a bus 812. The bus 812 can include hardware, software, or both that connects components of computing device 800 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
accessing a first training dataset comprising digital images with synthetic noise and corresponding ground-truth digital images for the digital images with synthetic noise;
accessing a second training dataset comprising digital images with natural noise;
training a domain gap generative adversarial network by:
generating, utilizing the domain gap generative adversarial network, predicted denoised images from the digital images with synthetic noise and predicted denoised images from the digital images with natural noise;
utilizing a discriminator to generate a first discrimination between the ground-truth digital images for the digital images with synthetic noise and the predicted denoised images for the digital images with synthetic noise, and a second discrimination between the predicted denoised images for the digital images with natural noise and the predicted denoised images for the digital images with synthetic noise; and
modifying parameters of the domain gap generative adversarial network based on the first discrimination and the second discrimination.

2. The computer-implemented method of claim 1, further comprising:
determining image loss and perceptual loss for predicted denoised images for the digital images with synthetic noise; and
modifying the parameters of the domain gap generative adversarial network further based on the image loss and the perceptual loss.

3. The computer-implemented method of claim 1, further comprising:
utilizing the first discrimination and the second discrimination to determine generative adversarial network loss; and
modifying the parameters of the domain gap generative adversarial network further based on the generative adversarial network loss.

4. The computer-implemented method of claim 1, further comprising:
utilizing the first discrimination to determine ground-truth synthetic logits based on the ground-truth digital images for the digital images with synthetic noise and the predicted denoised images for the digital images with synthetic noise;
utilizing the second discrimination to determine ground-truth natural logits based on the predicted denoised images for the digital images with natural noise and the predicted denoised images for the digital images with synthetic noise; and
applying a generative adversarial network loss algorithm to the ground-truth synthetic logits and the ground-truth natural logits to determine generative adversarial network loss.

5. The computer-implemented method of claim 4, further comprising:
utilizing a first discriminator to generate the first discrimination between the ground-truth digital images for the digital images with synthetic noise and the predicted denoised images for the digital images with synthetic noise; and
utilizing a second discriminator to generate the second discrimination between the predicted denoised images for the digital images with natural noise and the predicted denoised images for the digital images with synthetic noise.

6. The computer-implemented method of claim 1, further comprising generating, utilizing a trained domain gap generative adversarial network, a denoised digital image based on a digital image with natural noise.

7. The computer-implemented method of claim 1, further comprising generating the first training dataset by adding synthetic noise to a set of digital images.

8. A system comprising:
a memory component; and
a processing device coupled to the memory component, the processing device to perform operations comprising:
accessing a first training dataset comprising digital images with synthetic noise and corresponding ground-truth digital images for the digital images with synthetic noise;
accessing a second training dataset comprising digital images with natural noise;
training a domain gap generative adversarial network by:
generating, utilizing the domain gap generative adversarial network, predicted denoised images from the digital images with synthetic noise and predicted denoised images from the digital images with natural noise;
generating, utilizing a first discriminator, a first discrimination between the ground-truth digital images for the digital images with synthetic noise and the predicted denoised images for the digital images with synthetic noise;
generating, utilizing a second discriminator, a second discrimination between the ground-truth digital images for the digital images with synthetic noise and the predicted denoised images for the digital images with natural noise; and
modifying parameters of the domain gap generative adversarial network based on the first discrimination and the second discrimination.

9. The system of claim 8, wherein the operations further comprise:
determining image loss and perceptual loss for predicted denoised images for the digital images with synthetic noise; and
modifying the parameters of the domain gap generative adversarial network further based on the image loss and the perceptual loss.

10. The system of claim 8, wherein the operations further comprise:
utilizing the first discrimination and the second discrimination to determine generative adversarial network loss; and
modifying the parameters of the domain gap generative adversarial network further based on the generative adversarial network loss.

11. The system of claim 8, wherein the operations further comprise:
utilizing the first discriminator to determine ground-truth logits based on the ground-truth digital images for the digital images with synthetic noise;
utilizing the first discriminator to determine ground-truth synthetic logits based on the predicted denoised images for the digital images with synthetic noise; and
applying a generative adversarial network loss algorithm to the ground-truth logits and the ground-truth synthetic logits to determine generative adversarial network loss.

12. The system of claim 11, wherein the operations further comprise:
utilizing the second discriminator to determine natural logits based on the predicted digital images for the digital images with synthetic noise;
utilizing the second discriminator to determine synthetic logits based on the predicted denoised images for the digital images with natural noise; and
applying the generative adversarial network loss algorithm to the synthetic logits and the natural logits to determine the generative adversarial network loss.

13. The system of claim 8, wherein the operations further comprise generating, utilizing a trained domain gap generative adversarial network, a denoised digital image based on a digital image with natural noise.

14. The system of claim 8, wherein the operations further comprise generating the first training dataset by adding synthetic noise to a set of digital images.

15. A non-transitory computer-readable medium storing executable instructions which, when executed by a processing device, cause the processing device to perform operations comprising:
accessing a first training dataset comprising digital images with synthetic noise and corresponding ground-truth digital images for the digital images with synthetic noise;
accessing a second training dataset comprising digital images with natural noise;
training a domain gap generative adversarial network by:
generating, utilizing the domain gap generative adversarial network, predicted denoised images from the digital images with synthetic noise and predicted denoised images from the digital images with natural noise;
utilizing a discriminator to generate a first discrimination between the ground-truth digital images for the digital images with synthetic noise and the predicted denoised images for the digital images with synthetic noise, and a second discrimination between the predicted denoised images for the digital images with natural noise and the predicted denoised images for the digital images with synthetic noise; and
modifying parameters of the domain gap generative adversarial network based on the first discrimination and the second discrimination.

16. The non-transitory computer-readable medium of claim 15, wherein the operations further comprise:
determining image loss and perceptual loss for predicted denoised images for the digital images with synthetic noise; and
modifying the parameters of the domain gap generative adversarial network further based on the image loss and the perceptual loss.

17. The non-transitory computer-readable medium of claim 15, wherein the operations further comprise:
utilizing the first discrimination and the second discrimination to determine generative adversarial network loss; and
modifying the parameters of the domain gap generative adversarial network further based on the generative adversarial network loss.

18. The non-transitory computer-readable medium of claim 15, wherein the operations further comprise:
utilizing the first discrimination to determine ground-truth synthetic logits based on the ground-truth digital images for the digital images with synthetic noise and the predicted denoised images for the digital images with synthetic noise;
utilizing the second discrimination to determine ground-truth natural logits based on the predicted denoised images for the digital images with natural noise and the predicted denoised images for the digital images with synthetic noise; and
applying a generative adversarial network loss algorithm to the ground-truth synthetic logits and the ground-truth natural logits to determine generative adversarial network loss.

19. The non-transitory computer-readable medium of claim 18, wherein the operations further comprise:
utilizing a first discriminator to generate the first discrimination between the ground-truth digital images for the digital images with synthetic noise and the predicted denoised images for the digital images with synthetic noise; and
utilizing a second discriminator to generate the second discrimination between the predicted denoised images for the digital images with natural noise and the predicted denoised images for the digital images with synthetic noise.

20. The non-transitory computer-readable medium of claim 18, wherein the operations further comprise generating, utilizing a trained domain gap generative adversarial network, a denoised digital image based on a digital image with natural noise.
